(19) United States
(12) Patent Application Publication
(10) Pub. No.: US 2020/0070075 A1
(43) Pub. Date: Mar. 5, 2020

(54) FILTER MEDIUM FOR FUELS

(71) Applicant: Mahle International GmbH, Stuttgart (DE)

(72) Inventors: Peter Koppi, Sankt Margarethen (AT); Maria Kraut, St. Michael (AT); Julia Santer, Voelkermarkt (AT); Wolfgang Zupanc, Klagenfurt (AT)

(21) Appl. No.: 16/558,037

(22) Filed: Aug. 30, 2019

(30) Foreign Application Priority Data
Sep. 4, 2018 (DE) 102018215039.7

(51) Int. Cl. B01D 39/18; B01D 35/00; B01D 39/16; B01D 39/20; B32B 5/02; B32B 5/26

(52) U.S. Cl. CPC B01D 39/18; B32B 2307/726; B01D 39/1623; B01D 39/2017; B32B 5/022; B32B 5/26; B01D 2239/0622; B01D 2239/0654; B01D 2239/1216; B01D 2239/1291; B01D 2239/0618; B32B 2250/20; B32B 2262/02; B32B 2262/062; B32B 2262/101; B32B 2262/14; B32B 2307/73; B01D 35/005

(57) ABSTRACT

A filter medium for fuels may include a first layer of a filter material and a second layer of a filter material. A contact angle of water on the first layer of filter material may be greater than 90°. A contact angle of water on the second layer of filter material may be greater than 90°. The first layer of filter material may have an average pore diameter that is greater than an average pore diameter of the second layer of filter material.

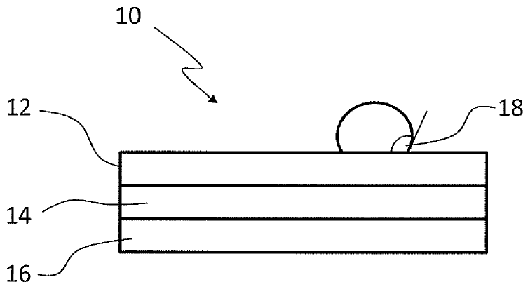

### CROSS-REFERENCE TO RELATED APPLICATIONS

This application claims priority to German Patent Application No. DE 10 2018 215 039.7, filed on Sep. 4, 2018, the contents of which are hereby incorporated by reference in its entirety.

### TECHNICAL FIELD

The invention relates to a filter medium for fuels, in particular biogenic fuels, with a first layer of filter material and with a second layer of filter material.

### BACKGROUND

Fuel filter media currently used have a shortened maintenance interval when biogenic fuels are used. Problems arise here not only with pure biogenic fuels but also especially with fuel mixtures comprising biogenic additions. The greatest challenge to the use of conventional filter media arises here from biogenic contaminants, which occur not only in dissolved form but also in finely dispersed form and can have high affinity to the fibre surfaces. The pores of the filter medium thus become prematurely blocked, and the capacity of the depth filter medium is greatly underutilized.

### SUMMARY

The present invention is based on the object of providing an improved, or at least different, design of a filter medium for biogenic fuels which in particular is characterized by an increased operating time.

This object is achieved according to the invention via the subject matter of the independent claim(s). The dependent claim(s) provide advantageous embodiments.

The invention is based on the fundamental concept that the two layers of filter material are configured to be hydrophobic, with resultant reduced accumulation of dispersed and dissolved biogenic contaminant particles. The invention therefore provides that a contact angle of water on the first layer of filter material is greater than 90°, that a contact angle of water on the second layer of filter material is greater than 90°, and that the first layer of filter material has an average pore diameter that is greater than an average pore diameter of the second layer of filter material. Contact angles, in particular of water, are a measure of the hydrophobicity of a medium. A contact angle greater than 90° means that polar liquids such as water, or biogenic contaminant particles, exhibit poor adhesion on the filter material. The filter material therefore becomes less susceptible to blockage by biogenic contaminant particles.

An example of a method that can be used to measure the contact angle of water on the filter material is the sessile drop method. This method places a droplet of water comprising a defined quantity of water on the surface of the filter material. The contact angle of the water on the filter material can be detected by means of optical methods, for example via a camera.

The contact angle above 90° can be achieved through suitable selection of the material or by coating. In the case of a coating, the raw fibre material can be coated before it is shaped to give the filter material. Alternatively, a coating can be provided subsequently to the finished filter material.

The pore size, i.e. the average pore diameter, can be measured in accordance with DIN EN ISO 4003. In particular, this gas bubble test can be used to determine in which layer of filter material has the greater pore diameter.

An advantageous possibility provides that the contact angle of water on the second layer of filter material is greater than 110°. The contact angle of water is a measure of the water-repellent action of the surface. Contaminants are particularly effectively repelled when the angle is greater than 110°.

A particularly advantageous possibility provides that the contact angle of water on the first layer of filter material and on the second layer of filter material is respectively greater than 120°. This results in very powerful action in repelling water and repelling contaminants both at the first layer of filter material and at the second layer of filter material. The biogenic contaminant particles from the fuels thus cannot achieve good adhesion either on the first layer of filter material or on the second layer of filter material. The life time of the filter material is thus increased.

Another particularly advantageous possibility provides that the contact angle of water on the second layer of filter material is greater than the contact angle of water on the first layer of filter material. The second layer is usually intended for the filtering of finer contaminant particles. The second layer is therefore particularly at risk from accumulation of biogenic contaminant particles. This possibility thus permits particularly good utilization of the advantages of the hydrophobic layers.

An advantageous variant provides that the filter material of the first layer has been produced in a meltblown process. Materials of this type produced in a meltblown process have very good suitability for filter media. It is moreover possible to use a variety of thermoplastics, and therefore hydrophobicity can be influenced via the selection of materials.

In a meltblown process, molten polymer is forced through a die block. Hot compressed air is used to draw the polymer after it has been discharged from the dies of the die block. The resultant microfibre web is laid on an air-permeable foraminous belt. The parameters can be selected in a manner that influences fibre thickness, pore diameter and web thickness. A filter material produced in this way can therefore be tailored extremely effectively to requirements.

Another advantageous variant provides that the weight per unit area of the filter material of the first layer is 50 to 70 g/m². With the specified weights per unit area it is possible to achieve a long life time.

A particularly advantageous variant provides that the second layer of filter material comprises glass fibres and cellulose fibres, and that the proportion by weight of the glass fibres in the filter material of the second layer is between 30% and 40%.

The glass fibres can have small fibre diameter in the low single-digit micrometre range, and thus permit design of media with high pore volume together with low actual pore diameters. It is thus possible to achieve high filtration performance levels with small differential pressure increases. By way of example, it is possible to achieve a high particle filtration performance level at which more than 99.9% of the particles larger than 4 μm are filtered.

An advantageous solution provides that in an intended flow direction the second layer of filter material is arranged downstream of the first layer of filter material. The different pore sizes of the two layers of filter material can thus be utilized advantageously. The first layer of filter material can serve for somewhat coarser filtering, while the second layer of filter material permits fine filtering.

Another particularly advantageous solution provides that the filter medium comprises a supportive layer arranged, in the intended flow direction, downstream of the second layer of filter material. Such a supportive layer can likewise have been produced from fibre material. The fibres of the supportive layer usually have a larger fibre diameter, associated however with larger pore diameter. The supportive layer therefore has little filter effect, and there is likewise little increase of flow resistance. The larger fibre diameter can however nevertheless achieve effective stabilization of the filter medium.

Another particularly advantageous solution provides that the supportive layer has an average pore diameter that is greater than the average pore diameter of the second layer of filter material. The supportive layer consequently has only little influence on the flow resistance of the filter medium.

An advantageous variant provides that the filter material of the supportive layer comprises cellulose fibres and synthetic fibres, and that the weight per unit area of the filter material of the supportive layer is between 150 and 220 g/m2

Another advantageous variant provides that the first layer of filter material and the second layer of filter material are in contact with one another. By this means, the multilayer structure of the filter medium can be achieved in a particularly advantageous manner.

Other important features and advantages of the invention are provided by the dependent claims, by the drawing and by the associated description of the FIGURE with reference to the drawing.

The abovementioned features, and the features that remain to be explained hereinafter, can of course be used not only in the respectively stated combination but also in other combinations or alone, without departing from the scope of the present invention.

The drawing depicts preferred working examples of the invention, which are explained in more detail in the description hereinafter.

### BRIEF DESCRIPTION OF THE DRAWINGS

The single FIGURE shows a section through a filter medium of the invention.

### DETAILED DESCRIPTION

An embodiment depicted in the FIGURE of a filter medium 10 for fuels comprises a first layer 12 of filter material and a second layer 14 of filter material. The filter medium moreover comprises a supportive layer 16. The first layer 12 and the second layer 14 and the supportive layer 16 are in contact with one another and are arranged in succession in an intended flow direction. The first layer 12 of filter material here is upstream of the second layer of filter material, while the support layer 16 is downstream of the second layer of filter material. The second layer of filter material is therefore arranged between the first layer 12 of filter material and the supportive layer 16.

In order to prevent excessive accumulation of biogenic contaminant particles which can be present in biogenic fuels, the first layer 12 of filter material and the second layer 14 of filter material are configured to be hydrophobic. A good measure of the hydrophobicity is provided by the contact angle of water on the filter material.

In order to achieve adequate lengthening of operating time, a contact angle 18 of water on the first layer 12 of filter material is greater than 90°. A contact angle 18 of water on the second layer 14 of filter material is likewise greater than 90°. Such a contact angle 18 above 90° can be achieved through suitable selection of the fibre material of the filter material. Alternatively, coatings or surface treatments of the fibre material can also lead to an increase of the contact angle.

The sessile drop method can be used to measure the contact angle.

It is preferable that the second layer 14 of filter material is more hydrophobic than the first layer 12 of filter material, i.e. that the contact angle 18 of water on the second layer 14 of filter material is greater than the contact angle 18 of water on the first layer 12. It is particularly preferable that the contact angles 18 of water respectively on the first layer 12 and on the second layer 14 are greater than 120°.

The first layer 12 and the second layer 14 of filter material additionally differ in average pore size. It is found to be advantageous for the operating time of the filter medium that the average pore diameter of the first layer 12 is greater than that of the second layer 14. As a result of this, only the coarser contamination particles are initially removed by filtration in the first layer 12 of filter material, whereas the finer contamination particles can then accumulate on the second layer 14 of filter material. The filtered contamination is thus distributed in the depth direction of the filter medium 10, and the filter medium 10 can therefore absorb a greater total quantity of contamination; this in turn increases the operating time of the filter medium 10.

A gas bubble test can be carried out to measure the pore size of the two layers of filter material. This is also described by way of example in DIN ISO 4003.

The first layer 12 comprises a filter material that has been produced in a meltblown process. Filter materials thus produced comprise thermoplastic fibres. By virtue of the large selection of possible plastics it is possible to achieve controlled adjustment of hydrophobicity. The weight per unit area of the first layer 12 of filter material is preferably between 50 and 70 g/m².

The second layer 14 of filter material comprises glass fibres and cellulose fibres. The proportion of the glass fibres is preferably between 30 and 40%.

Finally, a supportive layer 16 is also provided, which has an average pore diameter that of which is greater than the average pore diameter of the second layer 14 of fibre material. The average pore size of the supportive layer 16 is preferably also greater than the average pore size of the first layer 12 of fibre material.

The supportive layer 16 therefore does not increase flow resistance, or increases this only slightly. The supportive layer 16 is moreover preferably composed of fibres having a larger diameter than the fibres of the first layer 12 or of the second layer 14. The supportive layer 16 therefore has high mechanical stability, which can stabilize the filter medium itself.

The supportive layer 16 comprises cellulose fibres and synthetic fibres. The weight per unit area of the supportive layer 16 is preferably between 150 and 220 g/m².

If an application requires this, it is possible by way of example to fold the filter material after the three layers have been combined. The filter material can also, of course, have more than the said three layers. However, it is then preferable that all of the layers having filtering action are hydrophobic, i.e. have a contact angle 18 of water greater than 90°.

1. A filter medium for fuels, comprising a first layer of a filter material and a second layer of a filter material, wherein:
a contact angle of water on the first layer of filter material is greater than 90°;
a contact angle of water on the second layer of filter material is greater than 90°; and
the first layer of filter material has an average pore diameter that is greater than an average pore diameter of the second layer of filter material.

2. The filter medium according to claim 1, wherein the contact angle of water on the second layer of filter material is greater than 110°.

3. The filter medium according to claim 1, wherein the contact angle of water on the first layer of filter material and the contact angle of water on the second layer of filter material are greater than 120°.

4. The filter medium according to claim 1, wherein the contact angle of water on the second layer of filter material is greater than the contact angle of water on the first layer of filter material.

5. The filter medium according to claim 1, wherein the filter material of the first layer is a meltblown filter material.

6. The filter medium according to claim 1, wherein a weight per unit area of the filter material of the first layer is 50 to 70 g/m².

7. The filter medium according to claim 1, wherein:
the second layer of filter material includes a plurality of glass fibres and a plurality of cellulose fibres; and
a proportion by weight of the plurality of glass fibres in the filter material of the second layer is 30% to 40%.

8. The filter medium according to claim 1, wherein, in an intended flow direction, the second layer of filter material is arranged downstream of the first layer of filter material.

9. The filter medium according to claim 1, further comprising a supportive layer arranged, in an intended flow direction, downstream of the second layer of filter material.

10. The filter medium according to claim 9, wherein the supportive layer has an average pore diameter that is greater than the average pore diameter of the second layer of filter material.

11. The filter material according to claim 9, wherein:
the supportive layer comprises a filter material including a plurality of cellulose fibres and a plurality of synthetic fibres; and
a weight per unit area of the filter material of the supportive layer is 150 to 220 g/m².

12. The filter medium according to claim 1, wherein the first layer of filter material and the second layer of filter material are in contact with one another.

13. A filter medium for fuels, comprising a first layer of a hydrophobic first filter material and a second layer of a hydrophobic second filter material, the first layer and the second layer arranged in contact with one another, wherein:
the first filter material has a hydrophobicity such that a contact angle of water on the first layer is greater than 90°;
the second filter material has a hydrophobicity such that a contact angle of water on the second layer is greater than 90°; and
the first filter material has an average pore diameter that is greater than an average pore diameter of the second filter material.

14. The filter medium according to claim 13, wherein the first filter material includes a plurality of thermoplastic fibres.

15. The filter medium according to claim 13, wherein the second filter material includes a plurality of glass fibres and a plurality of cellulose fibres.

16. The filter medium according to claim 13, wherein the second filter material includes a plurality of glass fibres having a fibre diameter of less than 10 μm.

17. The filter medium according to claim 13, further comprising a porous supportive layer including a plurality of cellulose fibres and a plurality of synthetic fibres.

18. The filter medium according to claim 17, wherein an average pore diameter of the supportive layer is greater than the average pore diameter of the first filter material and is greater than the average pore diameter of the second filter material.

19. The filter medium according to claim 17, wherein:
the first filter material includes a plurality of thermoplastic fibres;
the second filter material includes a plurality of glass fibres and a plurality of cellulose fibres; and
a fibre diameter of fibres of the supportive layer is greater than a fibre diameter of fibres of the first filter material and greater than a fibre diameter of fibres of the second filter material.

20. A filter medium for fuels, comprising a plurality of layers stacked on one another in a flow direction, the plurality of layers including a first layer, a supportive layer, and a second layer disposed between the first layer and the supportive layer, wherein:
the first layer is composed of a hydrophobic first filter material, the first filter material having a hydrophobicity such that a contact angle of water on the first layer is greater than 90°;
the second layer is composed of a hydrophobic second filter material, the second filter material having a hydrophobicity such that a contact angle of water on the second layer is greater than 90°; and
the first filter material has an average pore diameter that is greater than an average pore diameter of the second filter material.
